(19) United States
(12) Patent Application Publication
(10) Pub. No.: US 2025/0392023 A1
(43) Pub. Date: Dec. 25, 2025

(54) ELECTRODE, ELECTRODE ASSEMBLY, AND RECHARGEABLE LITHIUM BATTERY INCLUDING THE SAME

(71) Applicant: SAMSUNG SDI CO., LTD., Yongin-si (KR)

(72) Inventors: Seung-Hun HAN, Yongin-si (KR); Hohyun JEONG, Yongin-si (KR); Junhyeok KWAK, Yongin-si (KR); Inkeol PARK, Yongin-si (KR); Jung Ock YEOU, Yongin-si (KR); Junghyun LEE, Yongin-si (KR)

(73) Assignee: SAMSUNG SDI CO., LTD., Yongin-si (KR)

(21) Appl. No.: 19/243,102

(22) Filed: Jun. 19, 2025

(30) Foreign Application Priority Data
Jun. 21, 2024 (KR) 10-2024-0081391

(51) Int. Cl. H01M 50/586; H01M 4/02; H01M 4/13; H01M 10/0525; H01M 10/42

(52) U.S. Cl. CPC H01M 50/586; H01M 4/13; H01M 10/0525; H01M 10/4235; H01M 2004/021

(57) ABSTRACT

Examples of the disclosure include an electrode, the electrode including a current collector, an active material layer coated on a portion of the surface of the current collector, and an insulating layer coated on an uncoated region of the surface of the current collector. The insulating layer includes a binder and inorganic particles, and the inorganic particles have an average particle diameter that is greater than or equal to about 2 μm. An electrode according to some example embodiments can obtain an effect of reducing or preventing a short circuit by hindering or preventing an insulating layer and/or an active material layer coated on a current collector from being peeled off.

### CROSS-REFERENCE TO RELATED APPLICATION

This application claims the benefit of priority to Korean Patent Application No. 10-2024-0081391 filed in the Korean Intellectual Property Office on Jun. 21, 2024, the entire contents of which are incorporated herein by reference.

### BACKGROUND

### 1. Field

Examples of the present disclosure relate to an electrode, an electrode assembly including the electrode, and a rechargeable lithium battery.

### 2. Description of the Related Art

A portable information device such as, e.g., a cell phone, a laptop, smart phone, and the like, or an electric vehicle, typically uses a rechargeable lithium battery having high energy density and ready portability as a driving power source. Accordingly, a rechargeable lithium battery with high energy density as a driving power source or power storage power source for hybrid or electric vehicles may be advantageous.

Rechargeable lithium batteries typically include a positive electrode and a negative electrode including an active material capable of intercalating and deintercalating lithium ions, and an electrolyte solution, and electrical energy is produced through oxidation and reduction reactions when lithium ions are intercalated/deintercalated from the positive electrode and negative electrode.

The positive and negative electrodes of a rechargeable lithium battery may have different areas. Accordingly, a small-area electrode can readily come into contact with a large-area electrode active material layer, causing a short circuit. Additionally, when a rechargeable lithium battery is rapidly charged, or operated at high output, a large amount of current may be concentrated at the positive and/or negative electrodes. This can cause overheating and ignition of rechargeable lithium batteries.

### SUMMARY

Examples of the disclosure include an electrode that reduces or prevents short circuits, and that has an active material layer that is not readily peeled off, an electrode assembly including the electrode, and a rechargeable lithium battery.

In some example embodiments, an electrode includes a current collector; an active material layer coated on a portion of the surface of the current collector; and an insulating layer coated on an uncoated region of the surface of the current collector. The insulating layer includes a binder and inorganic particles, and the inorganic particles have an average particle diameter (D₅₀) that is greater than or equal to about 2 μm.

In some example embodiments, an electrode assembly includes a stack in which a negative electrode, a separator, and a positive electrode are stacked, e.g., sequentially stacked, wherein at least one of the negative electrode and positive electrode is the electrode.

Some example embodiments include a rechargeable lithium battery including the electrode assembly and an electrolyte.

An electrode according to some example embodiments can achieve the effect of reducing or preventing a short circuit by hindering or preventing an insulating layer and/or an active material layer coated on a current collector from being readily peeled off.

### BRIEF DESCRIPTION OF THE DRAWINGS

FIG. 1 is a drawing illustrating a structure in which an insulating layer simultaneously or contemporaneously covers the side surface of the active material layer and a portion of the uncoated region of the current collector, but that does not cover the upper surface of the active material layer.

FIG. 2 is a drawing illustrating a structure in which an insulating layer simultaneously or contemporaneously covers portions of the lower and upper surfaces of an active material layer, a side surface of the active material layer, and a portion of an uncoated region of a current collector.

FIGS. 3 to 6 are cross-sectional views schematically illustrating rechargeable lithium batteries according to some example embodiments.

### DETAILED DESCRIPTION

Hereinafter, example embodiments are described in detail so that those of ordinary skill in the art can readily implement them. However, this disclosure may be embodied in many different forms and is not construed as limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but these terms do not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It is understood that when an element such as a layer, film, region, or substrate is referred to as being “on” another element, the element can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

### Electrode

In some example embodiments, an electrode includes a current collector, an active material layer coated on a portion of the surface of the current collector, and an insulating layer coated on an uncoated region of the surface of the current collector, wherein the insulating layer includes a binder and inorganic particles, and the inorganic particles have an average particle diameter (D₅₀) that is greater than or equal to about 2 μm.

### Insulating Layer

In an electrode according to some example embodiments, an insulating layer is coated on an uncoated region of a current collector surface to which an active material is not coated, and the insulating layer includes a binder and inorganic particles, and the inorganic particles have an average particle diameter (D₅₀) that is greater than or equal to about 2 μm.

The insulating layer may overlap at least a portion of the surface of the active material layer, so that the boundary surface may be undefined.

Additionally, the insulating layer may be present on the surface on which the active material layer is formed, or may be present under the electrode. Such an insulating layer can reduce or minimize short circuits that may occur between the positive electrode current collector and the negative electrode, or between the positive electrode current collector and the negative electrode current collector, within the battery, and improve stability.

### Inorganic Particles

The inorganic particles may include an insulating material, for example, at least one of aluminum oxide (Al₂O₃), alumina hydroxide (AlOOH), silicon dioxide (SiO₂), magnesium oxide (MgO), titanium dioxide (TiO₂), hafnium oxide (HfO₂), tin oxide (SnO), cerium (IV) oxide (CeO₂), nickel oxide (NiO), zinc oxide (ZnO), calcium oxide (CaO), zirconium oxide (ZrO₂), yttrium oxide (Y₂O₃), silicon carbide (SiC), or a combination thereof.

An average particle diameter (D₅₀) of the above-mentioned inorganic particles is greater than or equal to about 2 μm, and may be, for example, in a range of about 2 μm to about 5 μm, about 2 μm to about 4 μm, or about 2 μm to about 3 μm. In general, the smaller the size of the inorganic particles, the larger the specific surface area of the inorganic particles, and thus a large amount of binder may be required to increase the adhesive strength thereof with the electrode plate. However, when the average particle size of the inorganic particles is within any of the above ranges, there is an advantage of desired or improved adhesive strength with the electrode plate even when a small amount of binder is included. In addition, when lithium ions pass through the insulating layer, the larger the size of the inorganic particles included in the insulating layer, the shorter the migration path and the easier it is to pass through. Therefore, as the size of the inorganic particles included in the insulating layer decreases, lithium bypass occurs, which increases the amount of lithium precipitation and reduces the charge/discharge capacity and efficiency. In addition, as the size of the inorganic particles increases, there may be phase stability degradation due to precipitation of the inorganic particles when the slurry is left to stand after manufacturing the non-porous insulating slurry. Therefore, when the average particle size of the inorganic particles is within any of the above ranges, lithium bypass is reduced, which has the advantage of reducing the amount of lithium precipitation and increasing the charge/discharge capacity.

A specific surface area of the aforementioned inorganic particles may be in a range of about 0.1 m²/g to about 10 m²/g, for example about 0.2 m²/g to about 9 m²/g, about 0.4 m²/g to about 8 m²/g, about 0.6 m²/g to about 7 m²/g, about 0.8 m²/g to about 6 m²/g, or about 1 m²/g to about 5 m²/g. As described above, the larger the specific surface area of the inorganic particles, the more binder is required to increase the adhesive strength with the electrode plate. However, when the specific surface area of the inorganic particles is within any of the above ranges, there is an advantage of desired or improved adhesive strength with the electrode plate even when a small amount of binder is included.

The inorganic particles may be included in an amount in a range of about 30 wt % to about 60 wt %, for example, about 35 wt % to about 60 wt %, about 35 wt % to about 55 wt %, or about 40 wt % to about 55 wt % based on 100 wt % of the total insulating layer. When the content of inorganic particles is within any of the above ranges, the insulating layer can have desired or improved insulating properties and an appropriate adhesive strength.

### Binder

The binder can attach materials within the insulating layer to each other and can adhere the insulating layer to the current collector.

The binder may include a water-insoluble binder, a water-soluble binder, or a combination thereof.

The water-insoluble binder may include at least one of polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, a non-aqueous rubber-based binder, or a combination thereof.

The non-aqueous rubber-based binder may include at least one of a styrene-butadiene rubber (SBR), an acrylated styrene-butadiene rubber, an acrylonitrile-butadiene rubber (ABR), an acrylic rubber, a butyl rubber, a fluorine rubber, and a combination thereof.

The above water-soluble binder may include a rubber-based binder or a polymer resin binder. The rubber-based binder may be or include at least one of a styrene-butadiene rubber (SBR), an acrylated styrene-butadiene rubber, an acrylonitrile-butadiene rubber (ABR), an acrylic rubber, a butyl rubber, a fluorine rubber, and a combination thereof. The polymer resin binder may be or include at least one of polyethyleneoxide, polyvinylpyrrolidone, polyepichlorohydrin, polyphosphazene, polyacrylonitrile, ethylenepropylenedienecopolymer, polyvinylpyridine, chlorosulfonatedpolyethylene, latex, a polyester resin, an acrylic resin, a phenol resin, an epoxy resin, polyvinyl alcohol, and a combination thereof.

When a water-soluble binder is included as the binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be or include at least one of Na, K, or Li

The binder may be included in an amount in a range of about 40 wt % to about 70 wt %, for example about 40 wt % to about 65 wt %, about 45 wt % to about 65 wt %, or about 45 wt % to about 60 wt % based on a total weight 100 wt % of the insulating layer. When the content of the binder is within any of the above ranges, the insulating layer can exhibit desired or improved insulating properties and an appropriate adhesive strength.

### Active Material Layer

According to the electrode according to some example embodiments, an active material layer is coated on a portion of a surface of a current collector.

### Positive Electrode Active Material Layer

When the electrode according to some example embodiments is a positive electrode, a compound capable of reversible intercalation and deintercalation of lithium (lithiated intercalation compound) can be included as the active material. Specifically, one or more types of composite oxides of lithium and a metal such as or including at least one of cobalt, manganese, nickel, and a combination thereof may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<α<2); LiₐNi_{1-b-c}Mn_{b}X_{c}O_{2-α}D_{α} (0.90≤α≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may include, for example, at least one of lithium nickel-based oxide represented by Chemical Formula 11, lithium cobalt-based oxide represented by Chemical Formula 12, a lithium iron phosphate-based compound represented by Chemical Formula 13, cobalt-free lithium nickel-manganese-based oxide represented by Chemical Formula 14, or a combination thereof.

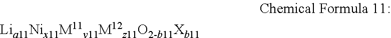

In Chemical Formula 11, 0.9≤a11≤1.8, 0.3≤x11≤1, 0≤y11≤0.7, 0≤z11≤0.7, 0.9≤x11+y11+z11≤1.1, and 0≤b11≤0.1, M¹¹ and M¹² each independently are or include one or more elements such as or including at least one of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 11, 0.6≤x11≤1, 0≤y11≤0.4, and 0≤z11≤0.4, or 0.8≤x11≤1, 0≤y11≤0.2, and 0≤z11≤0.2.

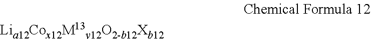

In Chemical Formula 12, 0.9≤a12≤1.8, 0.7≤x12≤1, 0≤y12≤0.3, 0.9≤x12+y12≤1.1, and 0≤b12≤0.1, M¹³ is or includes one or more of Al, B, Ba, Ca, Ce, Cr, Cu, Fe, Mg, Mn, Mo, Ni, Se, Si, Sn, Sr, Ti, V, W, Y, Zn and Zr, and X is or includes one or more of F, P, and S.

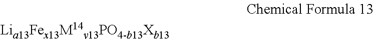

In Chemical Formula 13, 0.9≤a13≤1.8, 0.6≤x13≤1, 0≤y13≤0.4, and 0≤b13≤0.1, M¹⁴ is or includes one or more of Al, B, Ba, Ca, Ce, Co, Cr, Cu, Mg, Mn, Mo, Ni, Se, Si, Sn, Sr, Ti, V, W, Y, Zn, and Zr, and X is or includes one or more of F, P, and S.

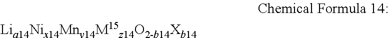

In Chemical Formula 14, 0.9≤a14≤1.8, 0.8≤x14<1, 0<y14≤0.2, 0≤z14≤0.2, 0.9≤x14+y14+z14≤1.1, and 0≤b14≤0.1, M¹⁵ is or includes one or more of Al, B, Ba, Ca, Ce, Cr, Fe, Mg, Mo, Nb, Si, Sn, Sr, Ti, V, W, and Zr, and X is or includes one or more of F, P, and S.

As an example, the active material may be or include a high nickel-based active material having a nickel content that is greater than or equal to about 80 mol %, greater than or equal to about 85 mol %, greater than or equal to about 90 mol %, greater than or equal to about 91 mol %, greater than or equal to about 94 mol %, or greater than or equal to 99 mol % based on 100 mol % of a metal excluding lithium in the lithium transition metal composite oxide. The high-nickel-based active materials can achieve high capacity and can be applied to high-capacity, high-density rechargeable lithium batteries.

When the electrode according to some example embodiments is a positive electrode, the active material layer includes the active material, and may further include a binder and/or a conductive material. For example, the content of the active material may be in a range of about 90 wt % to about 98 wt %, for example, about 90 wt % to about 95 wt % based on a total weight of the active material layer. The contents of the binder and the above conductive material may each be in a range of about 1 wt % to about 5 wt % based on a total weight of the active material layer.

The binder is configured to adhere the active material particles to each other, and also to adhere the active material to the current collector, and representative examples thereof may include at least one of polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is configured to provide conductivity to the electrode, and any material that does not cause a chemical change in the battery to be formed and is electronically conductive can be used. Examples of such a conductive material may include a conductive material including a carbon-based material such as at least one of natural graphite, artificial graphite, carbon black, acetylene black, ketjen black, a carbon fiber, and a carbon nanotube; a metal-based material including at least one of copper, nickel, aluminum, silver, etc. and in the form of a metal powder or a metal fiber; a conductive polymer such as a polyphenylene derivative; or a mixture thereof.

### Negative Electrode Active Material Layer

In some example embodiments, when the electrode is a negative electrode, the active material includes a material capable of reversibly intercalating/deintercalating lithium ions, lithium metal, an alloy of lithium metal, a material capable of doping and dedoping lithium, or a transition metal oxide.

The material that reversibly intercalates/deintercalates lithium ions may include, for example, at least one of crystalline carbon, amorphous carbon, or a combination thereof as a carbon-based active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based active material or a Sn-based active material. The Si-based active material may include at least one of silicon, a silicon-carbon composite, SiOₓ (0<x<2), a Si-Q alloy (wherein Q is an element such as or including at least one of an alkali metal, an alkaline-earth metal, a Group 13 element, a Group 14 element (excluding Si), a Group 15 element, a Group 16 element, a transition metal, a rare earth element, and a combination thereof, for example at least one of Mg, Ca, Sr, Ba, Ra, Sc, Y, Ti, Zr, Hf, Rf, V, Nb, Ta, Db, Cr, Mo, W, Sg, To, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof), or a combination thereof. The Sn-based active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be, for example, in a range of about 0.5 μm to about 20 μm. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include at least one of soft carbon or hard carbon, a mesophase pitch carbonized product, and calcined coke.

When the silicon-carbon composite includes silicon and amorphous carbon, a content of silicon may be in a range of about 10 wt % to about 50 wt % and a content of amorphous carbon may be in a range of about 50 wt % to about 90 wt % based on 100 wt % of the silicon-carbon composite. In addition, when the composite includes silicon, amorphous carbon, and crystalline carbon, a content of silicon may be in a range of about 10 wt % to about 50 wt %, a content of crystalline carbon may be in a range of about 10 wt % to about 70 wt %, and a content of amorphous carbon may be in a range of about 20 wt % to about 40 wt % based on 100 wt % of the silicon-carbon composite.

Additionally, a thickness of the amorphous carbon coating layer may be in a range of about 5 nm to about 100 nm. An average particle diameter (D₅₀) of the silicon particles (primary particles) may be in a range of about 10 nm to about 1 μm, or about 10 nm to about 200 nm. The silicon particles may exist as silicon alone, in the form of a silicon alloy, or in an oxidized form. The oxidized form of silicon may be represented by SiOₓ (0<x<2). At this time, the atomic content ratio of Si:O, which indicates a degree of oxidation, may be in a range of about 99:1 to about 33:67. As used herein, when a definition is not otherwise provided, an average particle diameter (D₅₀) indicates a particle where an accumulated volume is about 50 volume % in a particle distribution.

The Si-based active material or Sn-based active material may be mixed with the carbon-based negative electrode active material. When the Si-based active material or Sn-based active material and the carbon-based negative electrode active material are mixed and used, the mixing ratio may be a weight ratio in a range of about 1:99 to about 90:10.

When the electrode according to some example embodiments is a negative electrode, the active material layer includes the active material and may further include a binder and/or a conductive material.

The binder is configured to adhere the active material particles to each other, and also to adhere the active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be or include at least one of Na, K, or Li.

The conductive material is included to provide electrode conductivity, and any electrically conductive material may be included as a conductive material unless the electrically conductive material causes a chemical change in or to the battery.

The conductive material is included to provide electrode conductivity, and any electrically conductive material may be included as a conductive material unless the electrically conductive material causes a chemical change in or to the battery. Examples of the conductive material include a carbon-based material such as or including at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

### Current Collector

When the electrode according to some example embodiments is a positive electrode, aluminum foil may be included as the current collector, but the current collector is not limited thereto.

When the electrode according to some example embodiments is a negative electrode, the current collector may be or include at least one of a copper foil, a nickel foil, a stainless steel foil, a titanium foil, a nickel foam, a copper foam, a polymer substrate coated with a conductive metal, and a combination thereof, but the current collector is not limited thereto.

### Structure of Electrode

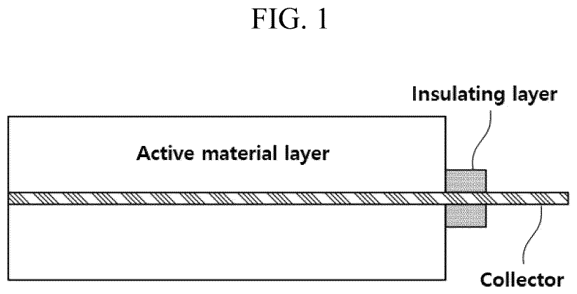

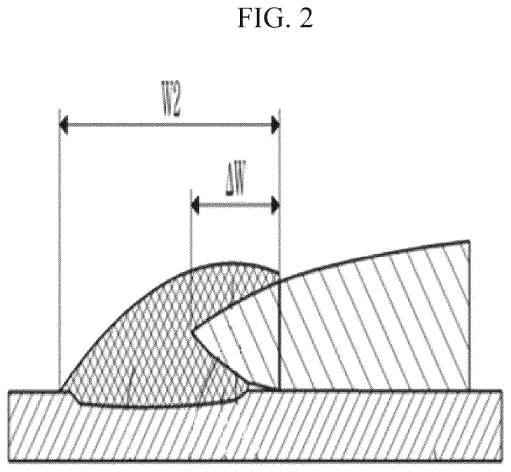

FIGS. 1 and 2 are schematic drawings illustrating electrodes according to some example embodiments, respectively. At this time, FIG. 1 shows a structure in which the insulating layer simultaneously or contemporaneously covers a side surface of the active material layer and a portion of the uncoated region of the current collector, but does not cover the upper surface of the active material layer, and FIG. 2 illustrates a structure in which the insulating layer simultaneously or contemporaneously covers a portion of the upper and lower surfaces of the active material layer, a side surface of the active material layer, and a portion of the uncoated region of the current collector.

The insulating layer may be located on each surface of the current collector (double-surface coating), or the insulating layer can be positioned on only one side of the current collector (single-surface coating). Compared to the single-surface coating, the double-surface coating may dissipate all heat generated inside and outside the rechargeable lithium battery, effectively reducing or suppressing overheating and ignition of the rechargeable lithium battery.

On the other hand, in the structure of FIG. 2, the insulating layer may have a total width (W2) in a range of about 0.5 mm to about 3.5 mm, for example, about 1 mm to about 3.5 mm, about 1 mm to about 3 mm, or about 1.5 mm to about 3 mm. In addition, a width (ΔW) of the upper surface of the active material layer, on which the insulating layer is coated, may be in a range of about 20 μm to about 300 μm, for example, about 50 μm to about 200 μm or about 70 to about 100 μm. When the width (ΔW) of the upper surface of the active material layer, on which the insulating layer is coated, is within any of the above ranges, it is possible to reduce or prevent a problem of exposing the uncoated current collector by distribution of the coating width, and simultaneously or contemporaneously, to reduce or prevent another challenge of deteriorating charge and discharge efficiency by intercalation/deintercalation of lithium ions during the charge and discharge due to a rise at edges of the electrode plate when the sum of the thickness of the electrode plate layer and the insulating layer is larger than the total thickness of the electrode plate.

The insulating layer and active material layer may independently have a substantially perpendicular end to the current collector, but may also have a sloping end, which may have a slope from the inner surface adjacent to the current collector to the outer surface.

The insulating layer may have a thickness in a range of about 1 μm to about 50 μm, for example, about 3 μm to about 45 μm, about 5 μm to about 40 μm, about 7 μm to about 35 μm, or about 10 μm to about 30 μm. Within any of the above ranges, the insulating layer may not only minimize a decrease in energy density during operation of the rechargeable lithium battery, but may also sufficiently contribute to ensuring safety and reliability.

In examples, the active material layer may have a thickness in a range of about 5 μm to about 100 μm, for example, about 10 μm to about 90 μm, about 20 μm to about 80 μm, about 30 μm to about 70 μm, or about 40 μm to about 60 μm. Herein, the active material layer may sufficiently contribute to capacity and/or output of the rechargeable lithium battery.

The insulating layer may be coated so as to overlap a portion of the upper surface of the active material layer, and a mixed phase of materials included in the active material layer and the insulating layer may be included at the interface between a portion of the upper surface of the active material layer and the insulating layer. In other words, in the mixed phase, a component included in the active material layer and a component included in the insulating layer may be mixed. The mixed phase may be formed over substantially the entire interface or at least a portion thereof, and may have a thickness variation according to a location.

The mixed phase may include a composition of the active material layer and the insulating layer. For example, in a conventional art, when the active material layer does not include a given element (X), but the insulating layer alone include the element (X), because their interface is recognized to have not the mixed phase but a clear boundary, the element (X) substantially may have a concentration of 0 at the active material layer side of the interface but an average composition of the active material layer at the insulating layer side of the interface.

However, in the electrode according to some example embodiments, the X concentration may decrease from an average concentration in the insulating layer to an average concentration in the active material layer in a direction from the insulating layer toward the current collector along the substantially perpendicular direction to the interface. In this way, on the interface of the insulating layer and the active material layer, a region having the composition of the insulating layer and the active material layer may be determined to be the mixed phase. More quantitatively, when focusing on the given element X, when the average concentration in the active material layer may be expressed as XA atom %, and the average concentration of the insulating layer is expressed as XS atom %, a region where X has a concentration between (90XA+10XS)/100 to (10XA+90XS)/100 may be considered as the mixed phase.

Regarding a thickness of the mixed phase, the largest width of the mixed phase in the substantially perpendicular direction to the interface may be defined as a maximum thickness of the mixed phase. In addition, as for multiple elements, in which different thicknesses of the mixed phase may be obtained, a largest one among the multiple elements may be used as the maximum thickness of the mixed phase. The larger the maximum thickness of the mixed phase, the more solid bonding between the active material layer and the insulating layer, which is desirable.

The mixed phase may be observed by using an electron beam microanalyzer (EPMA). The electrode is cured with a resin, cut substantially perpendicularly to the interface, and subjected to a cross-section analysis with EPMA to visually observe a region of the mixed phase through the element distribution mapping, and readily obtain a thickness and a maximum thickness of the mixed phase. In addition, a region having a different element distribution from those of the active material layer and the insulating layer is regarded as the mixed phase, the thickness and maximum thickness of which may be obtained. In other words, referring to the EPMA analysis results, a concentration of the given element X may be obtained along the substantially perpendicular direction to the interface to determine the maximum thickness of the mixed phase.

### Method for Manufacturing Electrode

In some example embodiments, a method of manufacturing the electrode may include forming the insulating layer on at least one surface of a current collector by using an insulating layer solution.

In addition, the insulating layer may be formed on the current collector where the active material layer is formed, or where the active material layer is not formed, and also simultaneously or contemporaneously formed with the active material layer. When the insulating layer is formed on the current collector where the active material layer is formed, the insulating layer may be formed on a portion of the surface of the active material layer and a portion of the uncoated region in which the active material layer is not formed, wherein the mixed phase is formed where the insulating layer and the active material layer overlap each other.

The electrode-manufacturing method may further include forming the active material layer on at least one surface of the current collector. Herein, there may be no particular limit to a method of forming the active material layer, for example, the active material layer may be formed by coating an active material slurry on the current collector and when necessary, drying and/or compressing the active material slurry.

The coating may be performed in various ways such as, e.g., slot die coating, shutter coating, gravure coating, and the like. The active material layer may indicate a state where the active material slurry is completely dried after applying the active material slurry on at least one surface of the current collector. For example, when the active material slurry is simultaneously or contemporaneously dried with the insulating layer solution, the active material layer refers to the applied active material slurry, and when the active material slurry is dried at a different time from the insulating layer solution to be described below, the active material layer may refer to a state where the applied active material slurry is substantially completely dried.

The active material slurry may be coated on a portion of one surface, or the entire one surface, of the current collector. For example, the active material slurry may be coated on a portion (a coated region) of one surface of the current collector but not on the other portion (uncoated region) of the surface of the surface of the current collector to form a predetermined or desired pattern. However, considering that the insulating layer is introduced in order to reduce or prevent a short circuit between positive and negative electrodes, the active material slurry may be desirably coated only on one surface of the current collector to have the coated region and the uncoated region.

### Rechargeable Lithium Battery

In some example embodiments, an electrode assembly includes a stack in which a negative electrode, a separator, and a positive electrode are stacked, e.g., sequentially stacked, wherein at least one of the negative electrode and the positive electrode is the aforementioned electrode according to some example embodiments.

In some example embodiments, a rechargeable lithium battery includes the electrode assembly according to the aforementioned example embodiments, and an electrolyte.

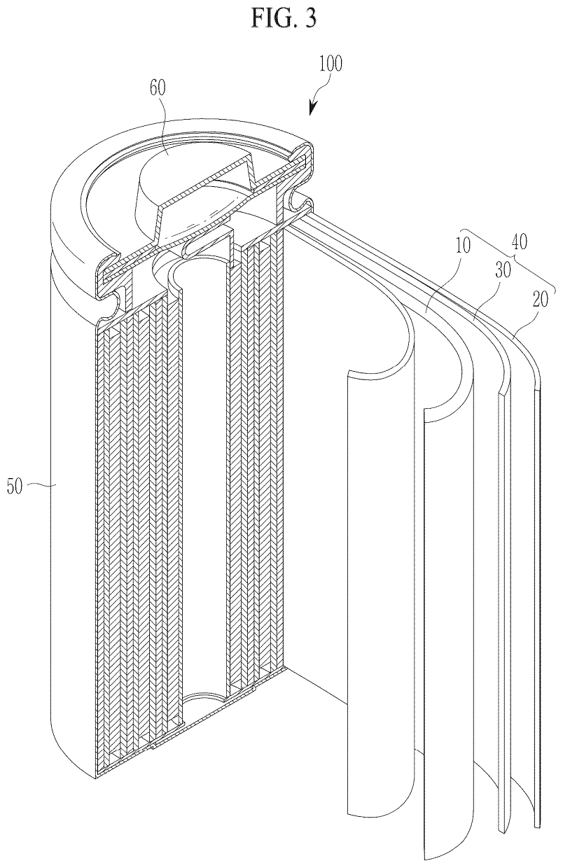

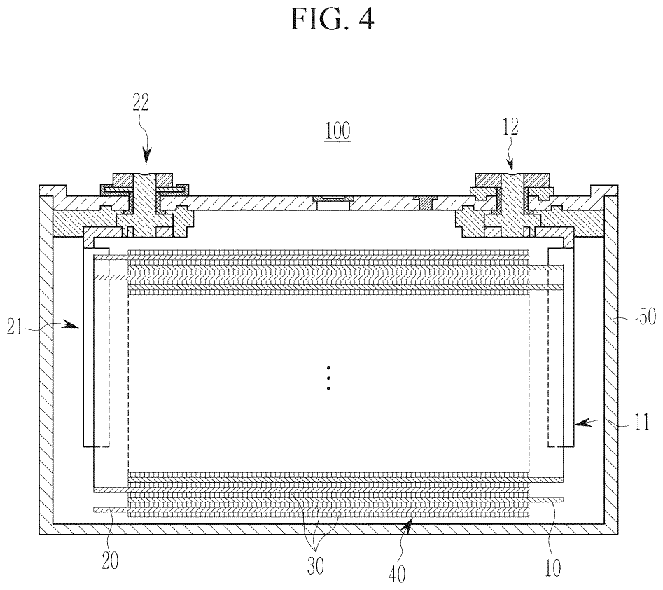

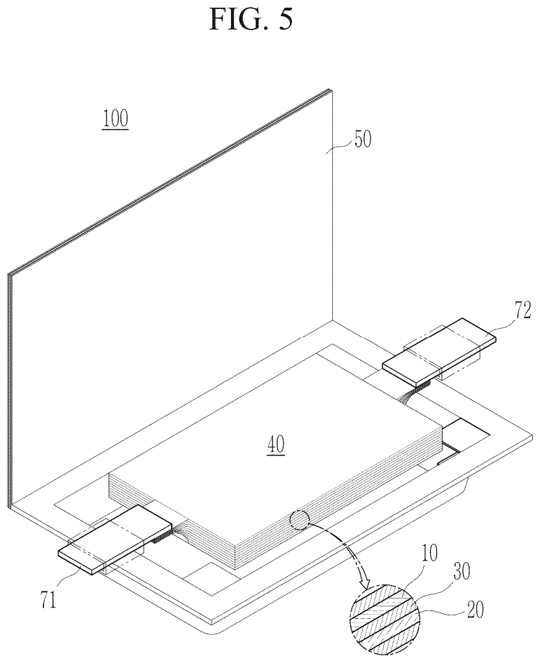

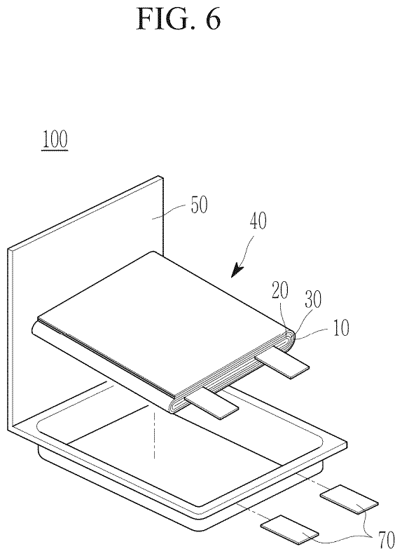

The rechargeable lithium battery may be classified into cylindrical, prismatic, pouch, coin, etc. depending on the shape. FIGS. 3 to 6 are schematic views illustrating the rechargeable lithium battery according to some example embodiments, where FIG. 3 is a cylindrical battery, FIG. 4 is a prismatic battery, and FIGS. 5 and 6 are a pouch-shaped battery. Referring to FIGS. 3 to 6, a rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 3. Additionally, in FIG. 4, the rechargeable lithium battery 100 may include a positive electrode lead tab 11, a positive electrode terminal 12, a negative lead tab 21, and a negative electrode terminal 22. As shown in FIGS. 5 and 6, the rechargeable lithium battery 100 includes an electrode tab 70 illustrated in FIG. 6, or a positive electrode tab 71 and a negative electrode tab 72 illustrated in FIG. 5, the electrode tabs 70/71/72 forming an electrical path for inducing the current formed in the electrode assembly 40 to the outside of the battery 100.

### Positive Electrode

The electrode assembly and the rechargeable lithium battery may each have an electrode according to the aforementioned example embodiment applied as a positive electrode. In this case, the description of the active material and the positive electrode including the same is as described above.

### Negative Electrode

The electrode assembly and the rechargeable lithium battery may each apply the electrode according to the aforementioned example embodiments as a negative electrode. In this case, the description of the active material and the negative electrode including the same is as described above.

### Electrolyte

The electrolyte may be or include an electrolyte solution, which may include a non-aqueous organic solvent and a lithium salt.

The non-aqueous organic solvent may constitute a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R-CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent can be alone or in a mixture of two or more types of solvents, and when two or more types are included in a mixture, a mixing ratio can be appropriately adjusted according to the desired battery performance, which is known to those working in the field.

When using a carbonate-based solvent, a cyclic carbonate and a chain carbonate may be mixed, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed in a volume ratio in a range of about 1:1 to about 30:1.

The electrolyte solution may further include at least one of vinylethyl carbonate, vinylene carbonate, or an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LIPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂) (C_{y}F_{2y+1}SO₂) (wherein x and y are integers of 1 to 20), lithium sulfonate, trifluoromethane lithium tetrafluoroethanesulfonate, lithium difluorobis(oxalato)phosphate (LiDFOB), and lithium bis(oxalato) borate (LiBOB).

A concentration of lithium salt may be within the range of about 0.1 M to about 2.0 M. When the concentration of lithium salt is within the above range, the electrolyte solution may have an appropriate or desired ionic conductivity and viscosity, and thus a desired or improved performance can be achieved, and lithium ions can move effectively.

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be or include a polymer film formed of or including any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include at least one of a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked together.

The thickness of the coating layer may be in a range of about 0.5 μm to about 20 μm, for example, about 1 μm to about 10 μm, or about 1 μm to about 5 μm.

Examples and comparative examples of the present disclosure are described below. However, the following examples are only examples of the present disclosure, and the present disclosure is not limited to the following examples.

### Example 1

### 1. Manufacturing of Positive Electrode

### (1) Preparation of Positive Electrode Slurry

LiCoO₂ as a positive electrode active material, CNT as a conductive material, and a spherical nanocarbon conductive material, and polyvinylidene fluoride (PVdF) as a binder were mixed in a weight ratio of 98.3:0.7:1 to obtain a mixture, and the mixture was mixed with N-methylpyrrolidone (NMP) to prepare a positive electrode slurry.

### (2) Preparation of Insulating Layer Slurry

Alumina hydroxide (AlOOH) with an average particle diameter (D₅₀) of 2.5 μm as inorganic particles, polyvinylidene fluoride (PVdF) as a binder, and a styrene-butadiene rubber (SBR) were mixed in a weight ratio of 70:15:15 to obtain a mixture, and the mixture was mixed with N-methylpyrrolidone (NMP) to prepare an insulating layer slurry.

### (3) Manufacturing of Positive Electrode

The positive electrode slurry and the insulating layer slurry were simultaneously coated in the middle of 74 mm (based on a width) of one surface of an aluminum substrate with each right and left side of 20 mm (based on a width) left as an uncoated region. Herein, the insulating layer slurry was coated to form an insulating layer with a width of 2.7 mm and a thickness of 20 μm, while simultaneously coating a portion of an upper surface of the positive electrode active material layer, sides of the positive electrode active material layer, and a portion of the uncoated region of the aluminum substrate, and then, a vision automatic inspection machine was used to measure a width of an overlapped portion, and the width was confirmed to be 70 μm to 100 μm.

The positive electrode active material layer and the insulating layer, in the state of being simultaneously formed on the aluminum substrate, were compressed to manufacture a positive electrode compressed body. Subsequently, the positive electrode compressed body was cut out from each left or right end by 37 mm (based on a width) with a cutting die with a width of 37 mm and a length of 25 mm. In the positive electrode cut body, the uncoated region of the aluminum substrate was additionally punched out to form a positive electrode substrate tab with a width of 10 mm and a length of 7 mm, finally obtaining a positive electrode.

### 2. Manufacturing of Negative Electrode

Artificial graphite as a negative electrode active material, carboxylmethyl cellulose as a thickener, and a styrene butadiene rubber as a binder were mixed in a weight ratio of 97.8:0.9:1.3 to prepare a mixture, and the mixture was mixed with water to prepare a negative electrode slurry.

The negative electrode slurry was coated at 10 mg/cm² to form a negative electrode active material layer in the middle of 78 mm (based on a width) of one surface of a copper substrate with each right and left side of 20 mm (based on a width) left as an uncoated region

The other surface of the copper substrate was equally treated to form a negative electrode active material layer.

As described above, the copper substrate with the negative electrode active material layers on the surfaces was compressed to manufacture a negative electrode compressed body. The negative electrode compressed body was cut out from each right or left end by 39 mm (based on a width) by using a cutting die with a width of 39 mm*a length of 27 mm. The negative electrode cut body was additionally punched out into a width 10 mm*a length 7 mm in the uncoated region of the copper substrate to form a negative electrode substrate tab, finally obtaining a negative electrode.

3. Manufacturing of Electrode Assembly and Rechargeable Lithium battery including the Electrode Assembly

A polyethylene separator was disposed between the positive electrode and the negative electrode to manufacture a laminate, and the laminate was wound and pressed in a vertical direction to manufacture a laminate-type electrode assembly.

The laminate-type electrode assembly was inserted into a pouch, and an electrolyte solution prepared by dissolving 1.0 M of a LiPF6 lithium salt in a mixed solvent of ethylene carbonate and diethyl carbonate in a volume ratio of 50:50 to manufacture a rechargeable lithium battery cell.

### Example 2

A positive electrode, an electrode assembly, and a rechargeable lithium battery cell were manufactured substantially in the same manner as in Example 1, with a difference that the average particle diameter (D₅₀) of alumina hydroxide (AlOOH) as inorganic particles were changed to 3 μm.

### Example 3

A positive electrode, an electrode assembly, and a rechargeable lithium battery cell were manufactured substantially in the same manner as in Example 1, with a difference that the average particle diameter (D₅₀) of alumina hydroxide (AlOOH) as inorganic particles were changed to 4 μm.

### Example 4

A positive electrode, an electrode assembly, and a rechargeable lithium battery cell were manufactured substantially in the same manner as in Example 1, with a difference that the width of the overlapped portion was changed to 50 μm to 200 μm from 70 μm to 100 μm out of the total width of 2.7 mm of the insulating layer.

### Example 5

A positive electrode, an electrode assembly, and a rechargeable lithium battery cell were manufactured substantially in the same manner as in Example 1, with a difference that the width of the overlapped portion was changed to 30 μm to 300 μm from 70 μm to 100 μm out of the total width of 2.7 mm of the insulating layer.

### Comparative Example 1

A positive electrode, an electrode assembly, and a rechargeable lithium battery cell were manufactured substantially in the same manner as in Example 1, with a difference that the average particle diameter (D₅₀) of alumina hydroxide (AlOOH) as inorganic particles was changed to 1 μm.

### Comparative Example 2

A positive electrode, an electrode assembly, and a rechargeable lithium battery cell were manufactured substantially in the same manner as in Example 1, with a difference that the average particle diameter (D₅₀) of alumina hydroxide (AlOOH) as inorganic particles was changed to 1.5 μm.

### Comparative Example 3

A positive electrode, an electrode assembly, and a rechargeable lithium battery cell were manufactured substantially in the same manner as in Example 1, with a difference that the width of the overlapped portion was changed to less than 20 μm from 70 μm to 100 μm out of the total width of 2.7 mm of the insulating layer.

### Comparative Example 4

A positive electrode, an electrode assembly, and a rechargeable lithium battery cell were manufactured substantially in the same manner as in Example 1, with a difference that the width of the overlapped portion was changed to greater than 300 μm from 70 μm to 100 μm out of the total width of 2.7 mm of the insulating layer.

### Evaluation Example 1: Evaluation of Adhesive Strength of Insulating Layer

In order to evaluate adhesive strength of an insulating layer according to an average particle diameter of inorganic particles, the insulating layer slurries according to Examples 1 to 3 and Comparative Examples 1 to 2 were respectively coated to form a 20 μm-thick insulating layer, preparing specimens. After punching out the specimens into a width of 25 mm and a length of 120 mm, adhering the obtained specimens onto a 25 mm-wide slide glass with a double-sided adhesive tape, slightly five times pressing the obtained specimens with a hand roller, mounting the obtained specimens on UTM (20 kgf load cell), and peeling one end of each positive electrode by about 25 mm, the peeled positive electrode was fixed into an upper clip, while the tape adhered on one surface of the positive electrode was fixed into a bottom clip, and then, peeled off at 100 mm/min to measure 180° peeling strength, and the measurements were averaged and then, provided in Table 1 below.

Additionally, the specimens prepared in the same method as above were dipped in an electrolyte solution, allowed to stand at 75° C. for 2 hours, and dried at 100° C. in an oven for 15 minutes and then, adhered to a slide glass by using a double-sided adhesive tape to measure wet adhesive strength, and the results are shown in Table 1 below.

TABLE 1

| | Inorganic | | | Adhesive | After cell |
|---|---|---|---|---|---|
| | particle | | | strength- | manufacturing, |
| | average | | Wet | wet | insulating |
| | particle | Adhesive | adhesive | adhesive | layer |
| | diameter | strength | strength | strength | detachment |
| | (D₅₀, μm) | (gf/mm) | (gf/mm) | (gf/mm) | result |
| Example 1 | 2.5 | 19.5 | 16.9 | 2.6 | Good |
| Example 2 | 3.0 | 21.6 | 20.1 | 1.5 | Good |
| Example 3 | 4.0 | 23.3 | 22.2 | 1.1 | Good |
| Comparative | 1.0 | 15.1 | 10.8 | 4.3 | Detached |
| Example 1 | | | | | |
| Comparative | 1.5 | 17.4 | 13.7 | 3.7 | Partially |
| Example 2 | | | | | detached |

Referring to Table 1, the positive electrodes of the examples using an insulating layer including alumina with an average particle diameter of 2 μm or more exhibited overall very desired or improved adhesive strength between current collector and insulating layer. However, the positive electrodes of the examples using an insulating layer including alumina with an average particle diameter of less than 2 μm exhibited deteriorated adhesive strength.

In addition, when the specimens after allowed to stand at a high temperature in an electrolyte solution was measured with respect to adhesive strength, the larger average particle diameter of the inorganic particles, the smaller difference between dry adhesive strength and wet adhesive strength, and in checking detachment of an insulating layer after manufacturing a cell, when the inorganic particles had a small average particle diameter, the insulating layer was detached.

### Evaluation Example 2: Evaluation of Phase Stability

In order to evaluate phase stability of an insulating layer slurry according to an average particle diameter of inorganic particles, the insulating layer slurries according to Examples 1 to 3 and Comparative Examples 1 to 2 were respectively placed in a 100 ml vial and allowed to stand without stirring and then, observed with respect to phase-10 separation phenomenon and analyzed with respect to a particle size (Mastersizer 3000, Malvern Panalytical Ltd.) every week, and the results are shown in Table 2 below.

TABLE 2

| | After | After | After | After | |
|---|---|---|---|---|---|
| | preparation | leaving it | leaving it | leaving it | |
| | of insulation | for one | for two | for three | |
| | slurry, | week, | weeks, | weeks, | |
| | particle | particle | particle | particle | Phase- |
| | size | size | size | size | separation |
| Example 1 | 2.53 | 2.53 | 2.55 | 2.58 | Good |
| Example 2 | 3.13 | 3.15 | 3.19 | 3.22 | Good |
| Example 3 | 4.05 | 4.10 | 4.44 | 4.88 | phase- |
| | | | | | separation |

Referring to Table 2, Examples 1 and 2 using inorganic particles with an average particle diameter of 3 μm or less exhibited no significant difference in phase stability, but Example 3 using inorganic particles with an average particle diameter of 4 μm exhibited the phase-separation phenomenon due to sedimentation of the inorganic particles.

### Evaluation Example 3: Evaluation of Initial Charge/Discharge Capacity and Efficiency

The rechargeable lithium battery cells of Examples 1 to 5 and Comparative Examples 1 to 4 were charged at a constant current of 0.2 C. to an upper limit voltage of 4.53 V and to 0.05 C. at the constant voltage and discharged to a cut-off voltage of 3.0 V at 0.2 C. at 25° C. for initial charge and discharge. In Table 3 below, initial charge capacity, initial discharge capacity, and a ratio of the latter to the former as efficiency are shown.

TABLE 3

| | 0.2 C charge | 0.2 C discharge | Efficiency |
|---|---|---|---|
| | (mAh/g) | (mAh/g) | (%) |
| Example 1 | 24.11 | 22.21 | 92.12 |
| Example 2 | 24.24 | 22.35 | 92.20 |
| Example 3 | 24.35 | 22.44 | 92.16 |
| Example 4 | 24.16 | 22.19 | 91.85 |
| Example 5 | 24.29 | 22.33 | 91.93 |
| Comparative Example 1 | 22.84 | 19.71 | 86.30 |
| Comparative Example 2 | 23.17 | 20.48 | 88.39 |
| Comparative Example 3 | 24.08 | 22.14 | 91.94 |
| Comparative Example 4 | 23.54 | 20.89 | 88.74 |

Referring to Table 2, the electrodes of the examples using an insulating layer including inorganic particles with an average particle diameter of 2 μm or more exhibited overall desired or improved charge/discharge capacity and efficiency. However, the electrodes of the comparative examples using an insulating layer including inorganic particles with an average particle diameter of less than 2 μm exhibited deteriorated charge/discharge capacity and efficiency.

Additionally, Comparative Example 3, which had a substantially small overlapped width of less than 20 μm, was confirmed to have a defect of exposing a portion of a current collector due to the generation of a non-overlapped region by coating process distribution, which led to a short circuit defect due to shrinkage of a separator, when exposed to heat. In addition, Comparative Example 4 had a large an overlapped portion of a width of greater than 300 μm so as to deteriorate the charge/discharge efficiency.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. An electrode, comprising
a current collector;
an active material layer coated on a portion of a surface of the current collector; and
an insulating layer coated on an uncoated region of the surface of the current collector,
wherein the insulating layer comprises a binder and inorganic particles, and
the inorganic particles have an average particle diameter (D₅₀) that is greater than or equal to about 2 μm.

2. The electrode as claimed in claim 1, wherein the inorganic particles comprise at least one of aluminum oxide, alumina hydroxide, silicon dioxide, magnesium oxide, titanium dioxide, hafnium oxide, tin oxide, cerium (IV) oxide, nickel oxide, zinc oxide, calcium oxide, zirconium oxide, yttrium oxide, and silicon carbide.

3. The electrode as claimed in claim 1, wherein the inorganic particles have an average particle diameter (D₅₀) in a range of about 2 μm to about 3 μm.

4. The electrode as claimed in claim 1, wherein the inorganic particles have a specific surface area in a range of about 0.1 m²/g to about 10 m²/g.

5. The electrode as claimed in claim 1, wherein the binder comprises one of a water-insoluble binder, a water-soluble binder, and a combination thereof.

6. The electrode as claimed in claim 1, wherein the binder is included in an amount in a range of about 45 wt % to about 60 wt % based on a total weight 100 wt % of the insulating layer.

7. The electrode as claimed in claim 1, wherein a thickness of the insulating layer is in a range about 1 μm to about 50 μm.

8. The electrode as claimed in claim 1, wherein
a thickness of the active material layer is in a range of about 5 μm to about 100 μm.

9. The electrode as claimed in claim 1, wherein the insulating layer is coated on a portion of an upper surface of the active material layer, on a side surface of the active material layer, and on the uncoated region.

10. The electrode as claimed in claim 9, wherein a width of the upper surface of the active material layer coated by the insulating layer is in a range of about 20 μm to about 300 μm.

11. The electrode as claimed in claim 9, wherein the insulating layer is coated so as to overlap a portion of the upper surface of the active material layer.

12. The electrode as claimed in claim 11, wherein a mixed phase of materials included in the active material layer and the insulating layer is included at the interface between a portion of the upper surface of the active material layer and the insulating layer.

13. The electrode as claimed in claim 12, wherein a concentration of the materials in the mixed phase is substantially perpendicular to the interface and decreases in a direction from the insulating layer toward the current collector.

14. An electrode assembly, comprising:
a stack in which a negative electrode, a separator, and a positive electrode are stacked,
wherein at least one of the negative electrode and the positive electrode is the electrode as claimed in claim 1.

15. A rechargeable lithium battery, comprising the electrode assembly as claimed in claim 14, and an electrolyte.
